(19) United States
(12) Patent Application Publication
(10) Pub. No.: US 2018/0053238 A1
(43) Pub. Date: Feb. 22, 2018

(54) ANALYTICS SYSTEM FOR PRODUCT PURCHASE MANAGEMENT

(71) Applicant: International Business Machines Corporation, Armonk, NY (US)

(72) Inventors: Tara Astigarraga, Fairport, NY (US); Nada Santiago, Poughkeepsie, NY (US); Christina A. Lara, Tucson, AZ (US); Maria R. Ward, Pflugerville, TX (US)

(21) Appl. No.: 15/242,967

(22) Filed: Aug. 22, 2016

(51) Int. Cl. G06Q 30/06; H04L 29/08; G06K 7/10; G06K 19/06

(52) U.S. Cl. CPC G06Q 30/0631; G06K 19/06037; G06K 7/10861; H04L 67/306

(57) ABSTRACT

A computer analytically recommends a softline good (SG) for purchase that is congruent with a SG profile of a preexisting SG and that is congruent with a user (UX) profile of the user of the computer. The computer determines the SG profile of the preexisting SG with background data associated with the preexisting SG obtained via a code associated with the SG and may determine additional background data associated with the SG from another computer, such as a computer of the SG manufacturer, computer of the retailer, or computer of another supply chain entity via a network. The computer determines the user profile with background data associated with an external I/O device external to the computer. The computer analytically recommends the SG for purchase if an electronic document of the SG contains data metrics similar to data metrics of the SG profile of the existing SG and similar to data metrics of the UX profile.

### FIELD OF THE INVENTION

Embodiments of the invention generally relate to computers and more particularly to a computing system that provides product purchase analytics to a user.

### DESCRIPTION OF THE RELATED ART

A softline good (SG) is a consumer product within apparel, shoe and accessory categories generally fabricated from soft, flexible materials. As opposed to a SG, a hardline good has a sturdier, less flexible structure or is sold within inflexible packaging. Generally, market trends that effect consumer market adoption of SGs have a shorter duration than the market trends that effect consumer market adoption of hardline goods. In some instances, the market trends of SGs dynamically change such that it has become difficult for the SG consumer to determine whether a particular SG is suitable for the SG consumer and whether he or she should, in turn, purchase the particular SG.

### SUMMARY

In an embodiment of the present invention, a method of managing a purchase recommendation of a softline good (SG) with a computer comprising a processor and memory includes analyzing an image of a code upon a label that is attached to a preexisting SG to determine first SG data, generating, with a SG profile module stored upon the memory, a SG profile comprising the first SG data, receiving, from an external input output (I/O) device connected to the computer by a short-range communication connection, user (UX) data describing the user of the computer and the external I/O device, generating, with a UX profile module stored upon the memory, a UX profile comprising the UX data, and recommending, with a natural language processing system, a second SG should be purchased. The recommending may be accomplished by comparing analyzed data within an electronic document of the second SG against the SG profile and against the UX profile, determining a number of congruent metrics between the electronic document of the second SG and the SG profile, determining a number of congruent metrics between the electronic document of the second SG and the UX profile, and determining a total number of congruent metrics between the electronic document of the second SG and the SG profile and between the electronic document of the second SG and the UX profile.

In another embodiment of the present invention, a computer program product for managing a purchase recommendation of a softline good (SG) with a computer includes a computer readable storage medium having program instructions embodied therewith that are readable by the computer to cause the computer to analyze an image of a code upon a label that is attached to a preexisting SG to determine first SG data, generate, with a SG profile module stored upon the memory, a SG profile comprising the first SG data, receive, from an external input output (I/O) device connected to the computer by a short-range communication connection, user (UX) data describing the user of the computer and the external I/O device, generate, with a UX profile module stored upon the memory, a UX profile comprising the UX data, and recommend, with a natural language processing system, a second SG should be purchased. The recommendation may be made by comparing analyzed data within an electronic document of the second SG against the SG profile and against the UX profile, determining a number of congruent metrics between the electronic document of the second SG and the SG profile, determining a number of congruent metrics between the electronic document of the second SG and the UX profile, and determining a total number of congruent metrics between the electronic document of the second SG and the SG profile and between the electronic document of the second SG and the UX profile.

In yet another embodiment of the present invention, a computer includes a processor and memory communicatively coupled to the processor. The memory is encoded with instructions that when executed by the processor cause the processor to analyze an image of a code upon a label that is attached to a preexisting SG to determine first SG data, generate, with a SG profile module stored upon the memory, a SG profile comprising the first SG data, receive, from an external input output (I/O) device connected to the computer by a short-range communication connection, user (UX) data describing the user of the computer and the external I/O device, generate, with a UX profile module stored upon the memory, a UX profile comprising the UX data, and recommend, with a natural language processing system, a second SG should be purchased. The recommendation may be made by the processor comparing analyzed data within an electronic document of the second SG against the SG profile and against the UX profile, determining a number of congruent metrics between the electronic document of the second SG and the SG profile, determining a number of congruent metrics between the electronic document of the second SG and the UX profile, and determining a total number of congruent metrics between the electronic document of the second SG and the SG profile and between the electronic document of the second SG and the UX profile.

These and other embodiments, features, aspects, and advantages will become better understood with reference to the following description, appended claims, and accompanying drawings.

### BRIEF DESCRIPTION OF THE DRAWINGS

FIG. 1 illustrates a high-level block diagram of an exemplary computer for implementing various embodiments of the invention.

FIG. 2 illustrates a high-level block diagram of an exemplary external input output (I/O) device connected to the computer for implementing various embodiments of the invention.

FIG. 3 illustrates a block diagram of a background-data module stored in memory of the computer that when invoked by the computer processor causes the computer to implement various embodiments of the present invention.

FIG. 4A and FIG. 4B illustrate exemplary SG codes associated with particular SG(s) that may be utilized by various embodiments of the invention.

FIG. 5 illustrates a block diagram of an example computing environment in which illustrative embodiments of the present disclosure may be implemented.

FIG. 6 illustrates a block diagram of an exemplary system architecture, including a natural language processing system, configured to use product reviews to rank product features, in accordance with embodiments of the present disclosure.

FIG. 7 illustrates an exemplary method of determining or creating a user profile, according to various embodiments of the present invention.

FIG. 8 illustrates an exemplary method of analytically recommending a SG having a SG profile similar to a preexisting SG profile, according to various embodiments of the present invention.

FIG. 9 illustrates an exemplary method of determining or creating a SG profile, according to various embodiments of the present invention.

FIG. 10 illustrates an exemplary method of analytically recommending a SG having a SG profile congruent with a preexisting user profile, according to various embodiments of the present invention.

FIG. 11 illustrates an exemplary method of managing an analytically determined purchase recommendation of a SG, according to various embodiments of the present invention.

It is to be noted, however, that the appended drawings illustrate only example embodiments of the invention, and are therefore not considered a limitation of the scope of embodiments of the invention.

### DETAILED DESCRIPTION

Embodiments relate to a computer that analytically recommends a SG that has a SG profile is similar to a SG profile of an existing SG and is congruent with the user's profile to, for example, assist the user whether he or she should purchase a SG. The computer determines the SG profile of the preexisting SG with background data associated with the preexisting SG obtained via a code upon the SG and may determine additional background data associated with the SG from another computer, such as a computer of the SG manufacturer, computer of the retailer, or computer of another supply chain entity via a network. The computer determines the user profile with background data associated with the user utilizing an external I/O device external to the computer and may determine additional background data associated with the user from another user profile to create the user's profile. The computer analytically recommends the SG if the SG has a SG profile similar to the SG profile of the existing SG and if the SG profile is congruent with the user's profile.

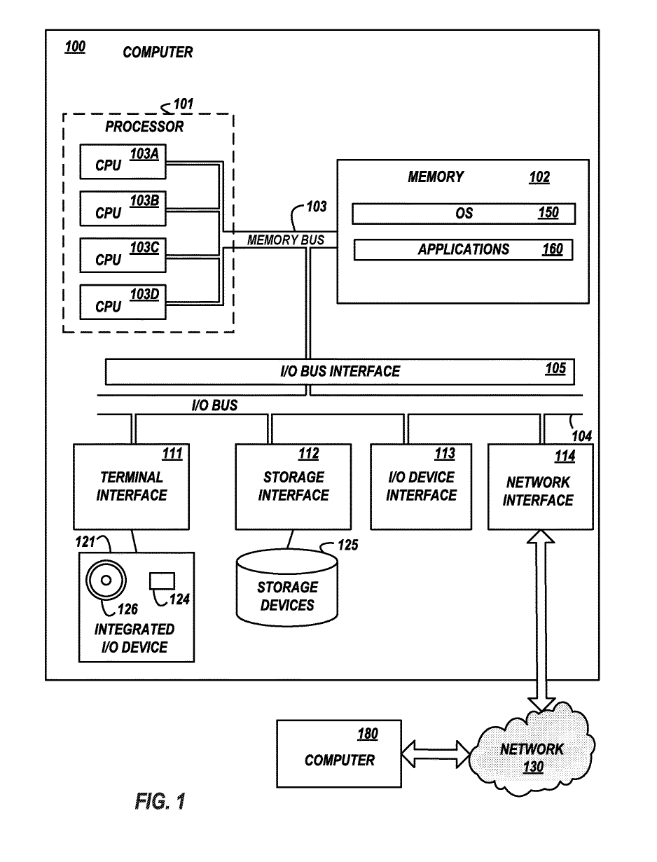

Referring to the Drawings, wherein like numbers denote like parts throughout the several views, FIG. 1 depicts a high-level block diagram representation of a computer 100 connected to another computer 180 via a network 130, according to an embodiment of the present invention. Computer 180 may include the same components, fewer components, or additional components as computer 100. The term “computer” is used herein for convenience only, and in various embodiments is a more general data handling system, such as a mobile phone, tablet, server computer, wearable device, etc. The mechanisms and apparatus of embodiments of the present invention apply equally to any appropriate data handling system. In a particular embodiment, computer 100 is a client computer such as a mobile phone and computer 180 is a host computer such as a server.

The major components of the computer 100 may comprise one or more processor 101, system memory 102, terminal interface 111, storage interface 112, I/O (Input/Output) device interface 113, and/or network interface 114, all of which are communicatively coupled, directly or indirectly, for inter-component communication via one or more busses, such as memory bus 103, I/O bus 104, an I/O bus interface unit 105, etc.

The computer 100 contains one or more general-purpose programmable central processing units (CPUs) 103A, 103B, 103C, and 103D, herein generically referred to as processor 101. In embodiments, the computer 100 contains multiple processors 101 typical of a relatively large system such as a server computer. Each processor 101 executes instructions stored in the system memory 102 and may comprise one or more levels of on-board cache. One of the multiple processors 101 may be a coprocessor. Generally, the coprocessor also executes instructions stored in the system memory 102 and may comprise one or more levels of on-board cache. The coprocessor generally allows the processor 101 to offload the execution of some instructions stored in the system memory 102 allowing the processor 101 to execute other instructions stored in the system memory 102. For example, the processor 101 may offload the execution of analytic instructions to the coprocessor. The coprocessor may also operate upon data that was previously operated upon by the processor 101 or upon data that will be subsequently operated upon by the processor 101. The offloading to the coprocessor generally allows for improved performed of particular instructions stored in the system memory 102. As such, the coprocessor may also be referred to as an accelerator, acceleration unit, or the like.

In an embodiment, the system memory 102 may comprise a random-access semiconductor memory, storage device, or storage medium for storing or encoding data and programs. In another embodiment, the system memory 102 represents the entire virtual memory of the computer 100, and may also include the virtual memory of other computers coupled to the computer 100 or connected via the network 130. The system memory 102 is conceptually a single monolithic entity, but in other embodiments the system memory 102 is a more complex arrangement, such as a hierarchy of caches and other memory devices. For example, memory 102 may exist in multiple levels of caches, and these caches may be further divided by function, so that one cache holds instructions while another holds non-instruction data, which is used by the processor 101. Memory may be further distributed and associated with different processors 101 or sets of processors 101, as is known in any of various so-called non-uniform memory access (NUMA) computer architectures.

The system memory 102 stores or encodes an operating system 150, and applications 160, and/or other program instructions. Although the operating system 150, applications 160, etc. are illustrated as being contained within the memory 102 in the computer 100, in other embodiments some or all of them may be on a different computer 180 and may be accessed remotely, e.g., via the network 130. The computer 100 may use virtual addressing mechanisms that allow the programs of the computer 100 to behave as if they only have access to a large, single storage entity instead of access to multiple, smaller storage entities. Thus, while operating system 150, applications 160, or other program instructions are illustrated as being contained within the system memory 102, these elements are not necessarily all completely contained in the same storage device at the same time. Further, although operating system 150, applications 160, other program instructions, etc. are illustrated as being separate entities, in other embodiments some of them, portions of some of them, or all of them may be packaged together, etc.

In an embodiment, operating system 150, application 160, and/or other program instructions comprise instructions or statements that execute on the one or more processors 101 and/or instructions or statements that are interpreted by instructions or statements that execute on the one or more processors 101 to carry out the functions as further described below. When such program instructions are able to be run by the one or more processors 101, such computer 100 becomes a particular machine configured to carry out such instructions.

One or more processors 101 may function as a general-purpose programmable graphics processor unit (GPU) that builds images (e.g. a GUI) for output to a display. The GPU, working in conjunction with one or more applications 160, determines how to manipulate pixels of a display, such as touch screen 124, to create a display image or user interface. Ultimately, the image (e.g. GUI, etc.) is displayed to a user via the display, such as touch screen 124. The processor 101 and GPU may be discrete components or may be integrated into a single component.

The memory bus 103 provides a data communication path for transferring data among the processor 101, the system memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The I/O interface units support communication with a variety of storage and I/O devices integral within the computer 100. For example, the terminal interface unit 111 supports the attachment of one or more integrated user I/O devices 121, which may comprise user output devices (such as a video display device, speaker, etc.) and user input devices (such as touchpad, buttons, etc.). In a particular embodiment, the terminal interface unit 111 is attached to an integrated camera 126 and integrated touch screen 124 as particular integrated I/O devices 121. The camera 126 and touch screen 124 allows the user to gesture, or touch, the touch screen 124 to instruct the computer 100 to capture an image with camera 126. A user may manipulate the integrated I/O devices 121 using a user interface, in order to provide input data and commands to the user I/O device 121 and the computer 100, and may receive output data via the user output devices. For example, the interface may be presented via the user I/O device 121, such as displayed on a display device, played via a speaker, or printed via a printer. The user interface may be a user interface that provides content to a user visually (e.g. via a screen), audibly (e.g. via a speaker), and/or via touch (e.g. vibrations, etc.). In some embodiments, the computer 100 itself acts as the user interface as the user may move the computer 100 in ways to interact with, input, or manipulate computer application 160 data, function, etc.

The storage interface unit 112 supports the attachment of one or more disk drives or storage devices 125. In an embodiment, the storage devices 125 are disk drive storage device(s), flash storage device(s), etc. and in embodiments the multiple devices are configured to appear as a single large storage device. The contents of the system memory 102, or any portion thereof, may be stored to and retrieved from the storage devices 125, as needed. The storage devices 125 generally have a slower access time than does the memory 102, meaning that the time needed to read and/or write data from/to the memory 102 is less than the time needed to read and/or write data from/to for the storage devices 125.

The I/O device interface 113 provides an interface to any of various other external input/output devices that are external to computer 100, such as a wearable device, a printer, etc. The network interface 114 provides one or more communications paths from the computer 100 to other data handling devices such as numerous other computers (e.g., computer 180); such paths may be comprised within, e.g., one or more networks 130.

Although the memory bus 103 is shown in FIG. 1 as a relatively simple, single bus structure providing a direct communication path among the processors 101, the system memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer 100 may, in fact, contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

Network interface 114 may contain electronic components and logic to adapt or convert data of one protocol on I/O bus 104 to another protocol. Therefore, network interface 114 may connect a wide variety of devices to computer 100 and to each other such as, but not limited to, servers, computers, bus adapters, PCI adapters, PCIe adapters, NVLink adapters, or computer 180 using one or more protocols including, but not limited to, Token Ring, Gigabit Ethernet, Ethernet, Fibre Channel, SSA, Fibre Channel Arbitrated Loop (FCAL), Serial SCSI, Ultra3 SCSI, Infiniband, FDDI, ATM, 1394, ESCON, wireless relays, Twinax, LAN connections, WAN connections, high performance graphics connections, etc.

Though shown as distinct entities, the multiple I/O interface units 111, 112, 113, and 114 or the functionality of the I/O interface units 111, 112, 113, and 114 may be integrated into the same device, adapter, etc.

In various embodiments, the computer 180 is a multi-user mainframe computer, a single-user system, a server computer, storage system, or similar device that has little or no direct user interface, but receives requests from other computers, such as computer 100. In such embodiments, the computer 100 may be implemented as a desktop computer, portable computer, laptop or notebook computer, tablet computer, pocket computer, telephone, smart phone, automobile infotainment console, teleconferencing system, appliance, or any other appropriate type of electronic device. In other embodiments, the computer 100 and computer 180 may be the same type of computer.

The network 130 may be any suitable network or combination of networks and may support any appropriate protocol suitable for communication of data and/or code to/from the computer 100 and at least the computer 180. In various embodiments, the network 130 may represent a data handling device or a combination of data handling devices, either connected directly or indirectly to the computer 100. In another embodiment, the network 130 may support wireless communications. In another embodiment, the network 130 may support hard-wired communications, such as a telephone line or cable. In another embodiment, the network 130 may be the Internet and may support IP (Internet Protocol). In another embodiment, the network 130 is implemented as a local area network (LAN) or a wide area network (WAN). In another embodiment, the network 130 is implemented as a hotspot service provider network. In another embodiment, the network 130 is implemented an intranet. In another embodiment, the network 130 is implemented as any appropriate cellular data network, cell-based radio network technology, or wireless network. In another embodiment, the network 130 is implemented as any suitable network or combination of networks. Although one network 130 is shown, in other embodiments any number of networks (of the same or different types) may be present.

FIG. 1 is intended to depict the representative major components of the computer 100. The individual components may have greater complexity than represented in FIG. 1, components other than or in addition to those shown in FIG. 1 may be present, and the number, type, and configuration of such components may vary. Several particular examples of such additional complexity or additional variations are disclosed herein; these are by way of example only and are not necessarily the only such variations. The various program instructions implementing e.g. upon computer 100 according to various embodiments of the invention may be implemented in a number of manners, including using various computer applications, routines, components, programs, objects, modules, data structures, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

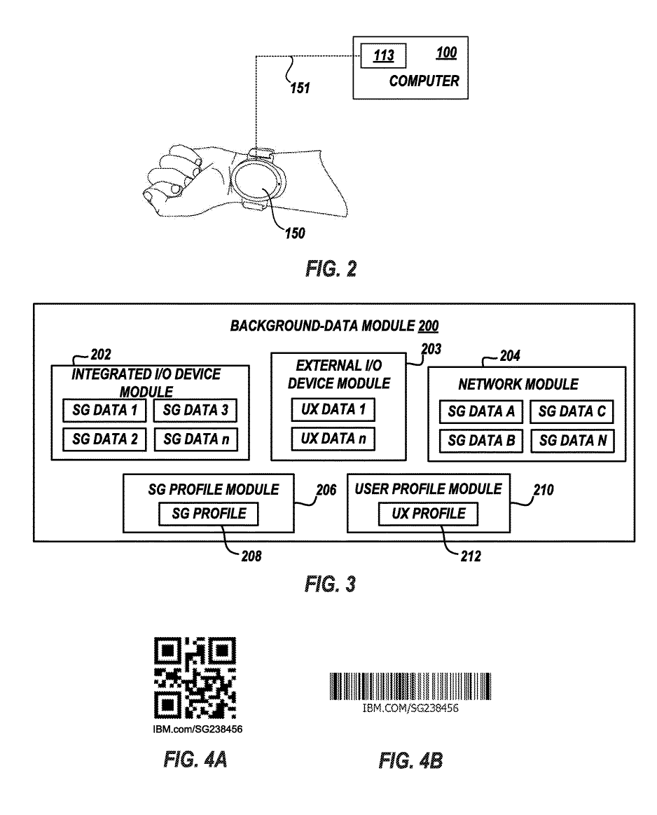

FIG. 2 illustrates a high-level block diagram of an exemplary external input output (I/O) device 150 connected to computer 100. In a particular example, external input output IO device 150 is a wearable device such as a smart watch, fitness tracker, or the like and is communicatively connected to computer 100 via a short-range communication connection 151 such as a Bluetooth connection, near field communication connection. Proximity protocol connection 151 is wireless personal-area network (WPAN) connection between computer 100 and external I/O device 150 used to exchange data to and/or from computer 100 and external I/O device 150. Various proximity protocol connections 151 are known in the art such as: ANT+, Bluetooth, Cellular, IEEE 802.15.4, IEEE 802.22, ISA 100a, Infrared, ISM band, NFC, RFID, 6LoWPAN, UWB, Wi-Fi, Wireless HART, WirelessHD, WirelessUSB, ZigBee, Z-Wave, or the like. In the context of the present document, the reach of a WPAN varies from a few centimeters to a few meters. Generally, external input output (I/O) device 150 is a data handling device and contains the same, fewer, or greater computing components relative to computer 100, as is shown in FIG. 1.

In a particular embodiment, external input output IO device 150 is connected to I/O device interface 113 of computer 100. The I/O device unit 113 of computer 100 generally supports the attachment of one or more external user I/O devices 150. The external input output IO device 150 may also contain a corollary unit to I/O device interface 113 of computer 100 that generally supports the attachment of one or more computers 100 so as to allow for data to be transferred between external IO device 150 and computer 100. In embodiments, the external input output IO device 150 may obtain or otherwise store user data of a user that is wearing the external input output IO device 150 such as the user's height, weight, body mass index, waist circumference, waist circumference, chest circumference, neck circumference, hip circumference, or the like.

FIG. 3 illustrates a block diagram of a background-data module 200 stored in memory 102 that when invoked by processor 101 causes the computer 100 to implement background-data accumulation operations. Background-data module 200 may include integrated I/O device module 202, external I/O device module 203, network module 204, SG profile module 206, and user profile module 210. Background-data module 200 may generally be a particular one or more applications 160 stored in memory 102.

Integrated I/O device module 202 is stored in memory 102 and when is invoked by processor 101, causes the computer 100 to utilize integrated I/O device 121 to accumulate background SG data. Similarly, network module 204 is stored in memory 102 and when is invoked by processor 101, causes the computer 100 to request and receive background SG data from computer 180 via network 130. Likewise, external I/O device module 203 is stored in memory 102 and when is invoked by processor 101, causes the computer 100 to request and receive background user data from external I/O device 150 via short-range communication connection 151.

SG profile module 206 is stored in memory 102 and when is invoked by processor 101, causes the computer 100 to create a SG profile 208 utilizing the background SG data accumulated by integrated I/O device module 202 and retrieved by network module 204 (if present). SG profile 208 is a set of data that describes a particular SG and may be stored in memory 102 or in one or more storage devices 125. There may be a single SG profile 208 for each particular SG.

Similarly, user profile module 210 is stored in memory 102 and when is invoked by processor 101, causes the computer 100 to create one or more user profiles 212. The user profile 212 is a set of data associated with the user of both computer 100 and external I/O device 150. At least some of the data of the user profile 212 includes data which was initially obtained by external I/O device 150 and received by user profile module 210. Multiple user profiles 212 may exist for the user of computer 100 and external I/O device 150.

In a preferred embodiment, the user I/O devices 121 are a camera 126 and touch screen 124 and integrated I/O device module 202 causes the computer 100, camera 126 and touch screen 124 to accumulate background SG data. In the present embodiment, the computer 100 user captures an image of a code, such as a Universal Product Code (UPC) code, Quick Response (QR) code, or the like, that is located upon, attached to, or otherwise associated with the SG. In general, the SG presently discussed in this paragraph is a SG owned, previously purchased, or the like, by a user. This SG may further be referred to herein as a preexisting SG and be associated with particular SG profile 208 which may similarly be referred to herein as a preexisting SG profile 208. Such SG may be a preferred SG of the user and the background data accumulation processes of the integrated I/O device module 202 may harvest SG data of the SG that describes the sizing, style, cut, color, or the like of the SG. The code may be integral to the soft material of the SG, may be located upon a manufacture's label attached to the SG, may be located upon a retailer's stock control label attached to the SG, or the like. Subsequently, integrated I/O device module 202 scans the image of the code to read or accumulate background data of the associated SG. The integrated I/O device module 202 scans the image of the code to determine background SG data, generally depicted as SG data 1 to SG data n associated with the particular SG. Exemplary background SG data may be an identifier of the SG, manufacturer of the SG, manufacturing location of the SG, price of the SG, style of the SG, cut of the SG, color of the SG, material of the SG, size of the SG, date of sale of the SG, date SG placed for sale, a web address containing additional SG data, or the like. In other embodiments, the I/O device 121 generally reads the code and accumulates background SG data therefrom. Generally, integrated I/O device module 202 accumulates background data of the SG by obtaining at least one SG data from user I/O device(s) 121. The SG data may point to additional SG data that which network module 204 may obtain from a computer 180 via network 130. For example, the SG data obtained from user I/O device 121 may be a web address associated with the SG. The network module 210 may direct a browser (visible or not visible to the user) to the web address and may harvest additional background SG data from the associated web page. The first SG data obtained by the I/O device module 202 and the additional SG data obtained from network module 204 may be integrated into a single SG profile 208 by SG profile module 206. A particular SG profile 208 may be designated as a preferred profile 208 by the user of computer 100. For example, the user may utilize an interface of computer 100 to designate a particular SG associated with the SG profile 208 as the SG profile 208 which includes SG data associated with a preferred fit, which includes SG data associated with a preferred cut SG, which includes SG data associated with a preferred color, which includes SG data associated with a preferred size, or the like.

Network module 204 generally requests and receives background data, generally depicted as SG data A, SG data B, SG data C, and SG data N associated with the preexisting SG from a networked connected computer 180. In some embodiments, computer 180 may computer system that is managed, operated, or controlled by an entity other than the user of computer 100 and external I/O device 150. For example, computer 180 may be controlled by a retailer that offers to sell the preexisting SG, manufacture of the preexisting SG, or the like. In other embodiments, computer 180 may be a computer controlled by a similar entity as that which develops or provides background data module 200.

Exemplary background SG data may be product recall information of the SG, sales trend data of the SG, manufacturing location of the SG, sale price of the SG, sale price discount history of the SG, expected market acceptance curve of the SG, to date market acceptance curve of the SG, customer recommendation data of the SG, time on floor before purchase, retail location of purchase, or the like. Since the computer 180 is controlled or managed by an entity other than that of computer 100, the quantity, quality, etc. of any background data SG data A-SG data N received by computer 100 is unknown. In an embodiment, network module 204 sends a specific request for particular background data from computer 180 and in another embodiment, network module 204 sends a blanket requests for any and all background data SG data A-SG data N. The background data SG data A-SG data N returned by computer 180 is generally structured data such that computer 100 knows to what the data refers. For example, computer 180 returns to computer 100 a data quantity $102.99 along with reference data describing to what or how that data quantity refers to the SG (e.g., the SG was sold for $102.99, a promotion or discount of $102.99 was given, etc.).

SG profile module 206 generally assembles the background SG data 1, SG data 2, SG data 3, SG data n and any background SG data A, SG data B, SG data C, and SG data N into a SG profile 208 which is a data package that describes the preexisting SG. The SG profile 208 of numerous preexisting SGs of the user may be stored in memory 102, in storage device 125, etc. In some embodiments, the SG profile module 206 may incorporate a web crawler or other software that allows the module to search for and automatically identify SG product data.

External I/O device module 203 generally requests and receives background data associated with the user of computer 100 and I/O device 150, generally depicted as UX data 1, UX data 2, etc. from I/O device 150. The I/O device 150 is smart watch or fitness tracker that tracks or otherwise contains biometric data of the user of I/O device 150. Exemplary background UX data may be user's current height, weight, waist circumference, neck circumference, chest circumference, foot width, foot length, or the like.

User profile module 210 determines or creates a user profile 212 of the user of computer 100 and the I/O device 150. User profile module 210 may have a question and answer module component which queues questions to and receives inputs from the user of computer 100 along with a component which requests the data received by I/O device module 203 that was previously contained with external I/O device 150. The user profile 212 is a data package that at least includes one UX data of the user of I/O device 150. In an embodiment, the user profile module 210 determines a user profile 212 which contains the user's body sizing data such as height, weight, waist circumference, neck circumference, chest circumference, foot width, foot length, or the like.

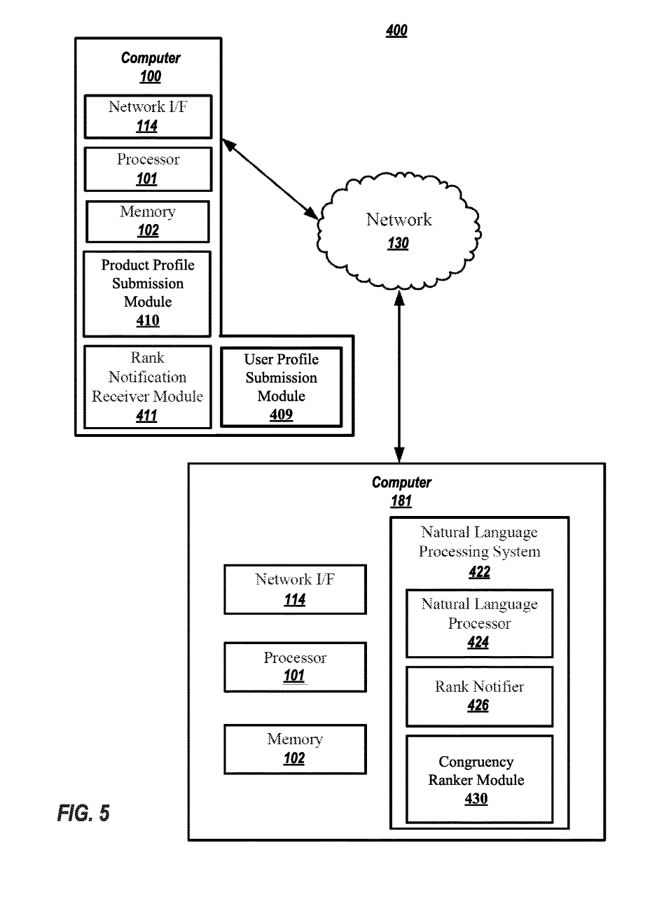

FIG. 4A and FIG. 4B illustrate exemplary SG codes associated with particular SG(s). FIG. 4A illustrates an exemplary QR code and FIG. 4B illustrates an exemplary bar code. Such code is located upon, attached to, or otherwise associated with the preexisting SG. The code may be integral to the soft material of the SG, may be located upon a manufacture's label attached to the SG, may be located upon a retailer's stock control label attached to the SG, or the like. The integrated I/O device 121 of computer 100 generally scans, captures an image, or the like of the code where, in turn, integrated I/O device module 202 processes the scan, image, etc. to determine one or more pieces of SG data from the code. The exemplary codes depicted are a code form of a particular web address (i.e., ibm.com/SG238456) of a particular SG. The particular web address is an exemplary piece of preexisting SG data. Network module 204 may receive and point to this web address and mine or harvest additional SG data included within the associated page. The first SG data retrieved by I/O device module 202 and the harvested SG data may be packaged into SG profile 208 by SG profile module 208.

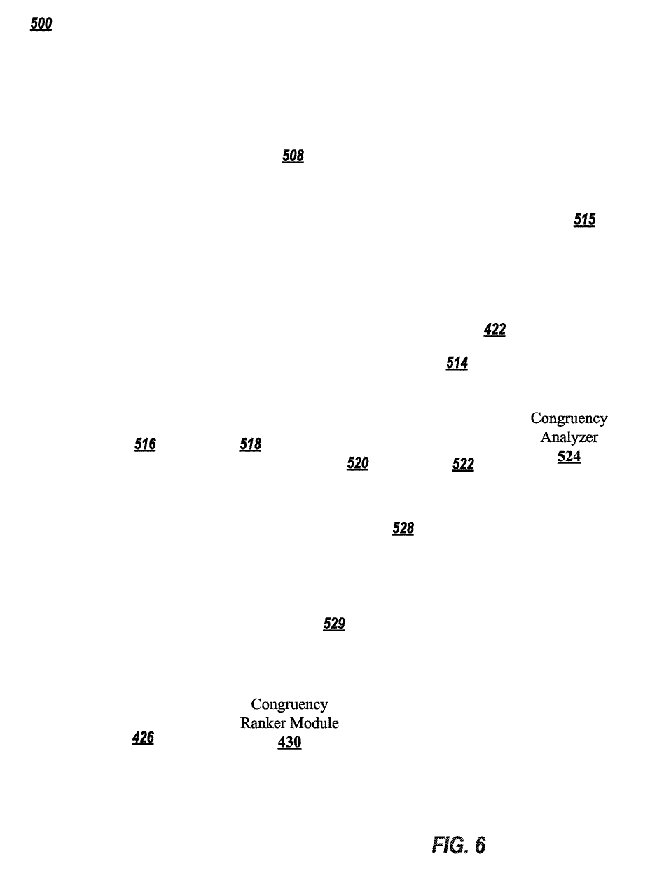

FIG. 5 illustrates a block diagram of an example computing environment 400 in which illustrative embodiments of the present disclosure may be implemented. In some embodiments, the computing environment 400 includes computer 100 which is configured as a remote device, which may be referred to herein as remote device, and a computer 181 which is configured as a host device, which may be referred to herein as host device. Computer 181 may have the same, fewer, or greater computing components relative to computer 100 shown in FIG. 1.

The remote device and the host device may include any commercially available or custom software (e.g., browser software, communications software, server software, natural language processing software, search engine and/or web crawling software, filter modules for filtering content based upon predefined parameters, etc.). The remote device and the host device may be distant from each other and communicate over network 130. In some embodiments, the host device may be a central hub from which remote device can establish a communication connection, such as in a client-server networking model. Alternatively, the host device and remote device may be configured in any other suitable networking relationship (e.g., in a peer-to-peer configuration or using any other network topology).

In certain embodiments, the remote device and the host device may be local to each other and communicate via any appropriate local communication medium. For example, the remote device and the host device may communicate using a local area network (LAN), one or more hardwire connections, a wireless link or router, or an intranet. In some embodiments, the remote device and the host device may be communicatively coupled using a combination of one or more networks and/or one or more local connections. For example, the remote device may be hardwired to the host device (e.g., connected with an Ethernet cable) while a second remote device (not shown) may communicate with the host device using the network 130 (e.g., over the Internet).

In some embodiments, the network 130 can be implemented within a cloud computing environment, or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over the network 130.

In some embodiments, the remote device may enable users to submit (or may submit automatically with or without user input) electronic documents (e.g., web pages) containing SG data of the SG profile 208 and the UX data of the user profile 212, to the host device(s) in order to have the SG profile 208 and user profile 212 ingested and analyzed for congruency with SG data of another SG (e.g., by natural language processing system 422) so as to make a purchase recommendation associated therewith. For example, the remote device may include user profile submission module 409 and product profile submission module 410 and a user interface (UI).

The user profile submission module 409 may be in the form of a web browser or any other suitable software module, the product profile submission module 410 may be in the form of a web browser or any other suitable software module, and the UI may be any type of interface (e.g., command line prompts, menu screens, graphical user interfaces). The UI may allow a user to interact with the remote device to submit, using the product profile submission module 410, the SG profile 208, one or more web pages containing the SG profile 208 which may contain reviews, images, etc. about the preexisting SG product to the host device. Likewise, the UI may allow a user to interact with the remote device to submit, using the user profile submission module 409, the UX profile 212 to the host device.

In some embodiments, the SG data being submitted via the product profile submission module 410 may all belong to (or may have all been created on a website that is owned by) the same entity that is submitting them for analysis. This may occur, for example, when a retail website submits SG data that to their retail website. In some other embodiments, the entity submitting the SG data may be different from the entity that originally received (e.g., collected) the SG data. This may occur, for example, when a retail website obtains product reviews from a third party (e.g., a consumer survey company), for free or for a fee, and then submits these reviews for analysis.

In some embodiments, the remote device may further include a congruency rank notification receiver module 411. This module may be configured to receive congruency notifications, from the host device, of the relative congruency ranks of various SG products in relation to the SG profile 208 and the UX profile 212 (i.e. the degree of similarity of the SG data of the various SGs that are offered for sale relative to the SG profile(s) 208 of the one or more preexisting SGs and the degree of how well the SG data of the various SGs that are offered for sale is compatible with the UX profile 212). In some embodiments, these relative ranks may then be used by the remote device to aid the user in determining which SG products he or she should consider when making a purchase decision. For example, these rankings may incorporated (by either the remote device or the host device) into web pages that allow consumers to use these received rankings for sorting through SG products.

In some embodiments, the host device may include a natural language processing system 422. The natural language processing system 422 may include a natural language processor 424, a rank notifier 426, and a congruency ranker module 430. The natural language processor 424 may include numerous subcomponents, such as a tokenizer, a part-of-speech (POS) tagger, a semantic relationship identifier, and a syntactic relationship identifier. An example natural language processor is discussed in more detail in reference to FIG. 6.

In some embodiments, the congruency ranker module 430 may be configured to rank SGs offered for sale based upon how congruent the SG data of those SGs are relative to the preexisting SG profile 208 and UX profile 212 based on an analytic analysis of the SG data of the SGs offered for sale. In addition, the rank notifier 426 may be connected to the congruency ranker module 430 and may serve to notify a user at the remote system (e.g., via the congruency notification receiver module 411) of the relative congruency ranks of various SG products offered for sale.

In some embodiments, the natural language processing system 422 may further include a search application (not shown). The search application may be implemented using a conventional or other search engine, and may be distributed across multiple computer systems. The search application may be configured to search one or more databases, data spaces, or other computer systems for product data of one or more SG products offered for sale. For example, the search application may be configured to search a corpus of information related to the one or more SG products offered for sale in order to identify the degree of congruency of the SG products offered for sale relative to the SG profile 208 and UX profile 212 associated with the submissions from the product profile submission module 410 and user profile submission module 409, respectively.

While FIG. 5 illustrates a computing environment 400 with a single host device and a single remote device, suitable computing environments for implementing embodiments of this disclosure may include any number of remote devices and host devices. The various modules, systems, and components illustrated in FIG. 5 may exist, if at all, across a plurality of host devices and remote devices. For example, some embodiments may include two host devices. The two host devices may be communicatively coupled using any suitable communications connection (e.g., using a WAN, a LAN, a wired connection, an intranet, or the Internet). The first host device may include a natural language processing system configured to ingest and annotate product reviews, and the second host device may include a software module configured to compare and rank product features based on the ingested product reviews.

It is noted that FIG. 5 is intended to depict the representative major components of an exemplary computing environment 400. In some embodiments, however, individual components may have greater or lesser complexity than as represented in FIG. 5, components other than or in addition to those shown in FIG. 5 may be present, and the number, type, and configuration of such components may vary.

Referring now to FIG. 6, shown is a block diagram of an exemplary system architecture 500, including a natural language processing system 422, configured to use SG data and UX data to determine other SG that are congruent thereto, in accordance with embodiments of the present disclosure. In some embodiments, a remote device (such as computer 100 of FIG. 5) may submit electronic documents or webpages (containing SG profile 208 and UX profile 212 to be analyzed) to the natural language processing system 422 which may be housed on a host device (such as computer 181 of FIG. 5). Such a remote device may include a client application 508, such as module 200, which may itself involve one or more entities operable to generate or modify information in the electronic documents or webpages that are then dispatched to a natural language processing system 422 via a network 515.

Consistent with various embodiments, the natural language processing system 422 may respond to electronic document submissions sent by the client application 508. Specifically, the natural language processing system 422 may analyze received SG profile 208 and UX profile 212 to aid in the congruency analysis of additional SG for consumer consideration. The natural language processing system 422 may also analyze electronic documents or webpages listing one or more SG offered for sale to determine whether SG data associated with the one or more SG offered for sale is congruent with SG profile 208 and UX profile 212 and to rank the one or more SG offered for sale based upon the degree of congruency.

In some embodiments, the natural language processing system 422 may include a natural language processor 514, data sources 528, a rank notifier 426, and a congruency ranker module 430.

The natural language processor 514 may be a computer module that analyzes received SG data and UX data within the electronic documents. The natural language processor 514 may perform various analytic methods and techniques for analyzing electronic documents (e.g., syntactic analysis, semantic analysis, etc.). The natural language processor 514 may be configured to recognize and analyze any number of natural languages. In some embodiments, the natural language processor 514 may parse passages of the documents. Further, the natural language processor 514 may include various modules to perform analyses of SG data and UX data. These modules may include, but are not limited to, a tokenizer 516, a part-of-speech (POS) tagger 518, a semantic relationship identifier 520, a syntactic relationship identifier 522, and congruency analyzer 524.

In some embodiments, the tokenizer 516 may be a computer module that performs lexical analysis. The tokenizer 516 may convert a sequence of characters into a sequence of tokens. A token may be a string of characters included in an electronic document and categorized as a meaningful symbol. Further, in some embodiments, the tokenizer 516 may identify word or numerical boundaries in an electronic document and break any text or numerical passages within the document into their component text or numerical elements, such as words, multiword tokens, numbers, punctuation marks, or the like. In some embodiments, the tokenizer 516 may receive a string of characters, identify the lexemes in the string, and categorize them into tokens.

Consistent with various embodiments, the POS tagger 518 may be a computer module that marks up a word in passages to correspond to a particular part of speech. The POS tagger 518 may read a passage or other text in natural language and assign a part of speech to each word or other token. The POS tagger 518 may determine the part of speech to which a word (or other text element) corresponds based on the definition of the word and the context of the word. The context of a word may be based on its relationship with adjacent and related words in a phrase, sentence, or paragraph. In some embodiments, the context of a word may be dependent on one or more previously analyzed electronic documents (e.g., the content of one product review may shed light on the meaning of text elements in another product review, particularly if they are reviews of the same product). Examples of parts of speech that may be assigned to words include, but are not limited to, nouns, verbs, adjectives, adverbs, and the like. Examples of other part of speech categories that POS tagger 518 may assign include, but are not limited to, comparative or superlative adverbs, wh-adverbs, conjunctions, determiners, negative particles, possessive markers, prepositions, wh-pronouns, and the like. In some embodiments, the POS tagger 518 may tag or otherwise annotate tokens of a passage with part of speech categories. In some embodiments, the POS tagger 518 may tag tokens or words of a passage to be parsed by other components of the natural language processing system 512.

In some embodiments, the semantic relationship identifier 520 may be a computer module that is configured to identify semantic relationships of recognized text elements (e.g., words, phrases) in documents. In some embodiments, the semantic relationship identifier 520 may determine functional dependencies between entities and other semantic relationships.

Consistent with various embodiments, the syntactic relationship identifier 522 may be a computer module that is configured to identify syntactic relationships in a passage composed of tokens. The syntactic relationship identifier 522 may determine the grammatical structure of sentences such as, for example, which groups of words are associated as phrases and which word is the subject or object of a verb. The syntactic relationship identifier 522 may conform to formal grammar.

Consistent with various embodiments, the congruency analyzer 524 may be a computer module that is configured to compare the SG profile 208 and the UX profile 212 with the SG data within electronic document(s) associated with the one or more SGs offered for sale to determine how similar the SG profile 208 and the UX profile 212 is to the SG data within electronic document(s).

In the context of the present document, the SG profile 208 is deemed congruent by congruency analyzer 524 with the SG data within electronic document(s) associated with the one or more SGs offered for sale (analyzed SG) if one or more SG metrics (data) of SG profile 208 are the same as the equivalent respective metric(s) or fit within a range of equivalent respective metrics of the analyzed SG. Thus, a SG metric is congruent if the SG metric is the same as the equivalent respective metric or fits within a range of equivalent respective metrics of the analyzed SG. For example, various SG metrics of the SG profile 208 would be deemed congruent with the SG data within electronic document(s) associated with the analyzed SG by congruency analyzer 524 if the preexisting SG has a thirty inch waist size and the analyzed SG also has a thirty inch waist size, if the preexisting SG and the analyzed SG are in the same style or trend, if the preexisting SG sleeve, neck, chest size and the analyzed SG sleeve, neck, chest size are the same, if the preexisting SG and the analyzed SG are in the same color family, if the preexisting SG and the analyzed SG are formed with the same pattern, or the like. The number of shared metrics between the SG profile 208 and the SG data within electronic document(s) associated with the analyzed SG generally increases the level or degree of congruency therebetween.

Similarly, in the context of the present document, the UX profile 212 is deemed congruent by congruency analyzer 524 with the SG data within electronic document(s) associated with the one or more SGs offered for sale (analyzed SG) if one or more UX metrics (data) of UX profile 212 are the same as the equivalent respective metric(s) of the analyzed SG or fit within a range of equivalent respective metric(s) of the analyzed SG. Thus, a UX metric is congruent if the UX metric is the same as the equivalent respective metric or fits within a range of equivalent respective metrics of the analyzed SG. For example, various UX metrics within the UX profile 212 would be deemed congruent with the SG data within electronic document(s) associated with the analyzed SG by congruency analyzer 524 if the UX height metric fits within a height range of a size guide of the analyzed SG, if the UX weight metric fits within a weight fit range of the size guide of the analyzed SG, if the UX body mass index metric fits within a body mass index fit range of the size guide of the analyzed SG, if the UX waist circumference metric fits within a waist circumference fit range of the size guide of the analyzed SG, if the UX neck circumference metric fits within a neck circumference fit range of the size guide of the analyzed SG, if the UX chest circumference metric fits within a chest circumference fit range of the size guide of the analyzed SG, if the UX foot width metric fits within a foot width fit range of the size guide of the analyzed SG, if the UX foot length metric fits within a foot length fit range of the size guide of the analyzed SG, or the like. The number of shared metrics between the UX profile 212 and the SG data within electronic document(s) associated with the analyzed SG generally increases the level or degree of congruency therebetween.

In some embodiments, the congruency analyzer 524 may be configured to identify, within text passages, and annotate keywords that are preselected as high quality indicators (e.g., indicators of positive sentiment could include brilliant, excellent, or fantastic, fits true to size, or the like). Various tools and algorithms may be used the congruency analyzer 524 as are known to those skilled in the art (e.g., Naïve Bayes lexical model).

In some embodiments, the natural language processor 514 may be a computer module that may parse a document and generate corresponding data structures for one or more portions of the document. For example, in response to receiving a set of product reviews from a website that includes a collection of consumer product reviews at the natural language processing system 422, the natural language processor 514 may output parsed text elements from the product reviews as data structures. In some embodiments, a parsed text element may be represented in the form of a parse tree or other graph structure. To generate the parsed text element, the natural language processor 514 may trigger computer modules 516-524.

In some embodiments, the output of the natural language processor 514 may be stored as an information corpus 529 in one or more data sources 528. In some embodiments, data sources 528 may include data warehouses, information corpora, data models, and document repositories. The information corpus 529 may enable data storage and retrieval. In some embodiments, the information corpus 529 may be a storage mechanism that houses a standardized, consistent, clean, and integrated copy of the ingested and parsed product reviews. Data stored in the information corpus 529 may be structured in a way to specifically address analytic requirements. For example, the information corpus 529 may store the ingested SG data based on groups of related SG products (e.g., products of the same type) in order to make ranking product features easier. In some embodiments, the information corpus 529 may be a relational database.

In some embodiments, the natural language processing system 422 may include a congruency ranker module 430. The congruency ranker module 430 may be a computer module that is configured to rank the analyzed SG(s) based upon the number of congruent metrics between SG profile 208 and the UX profile 212 and the SG data within electronic document(s) associated with the one or more SGs offered for sale. The congruency ranker module 430 may be further configured to weight any one or more particular congruent metrics based upon importance (i.e., degree of congruence with a preferred SG profile 208, degree of congruence with a particular metric within a particular SG profile 208 or UX profile 212, etc.).

The rank notifier 426 may be a computer module that is configured to notify users of analyzed SG rankings determined by the congruency ranker module 430. In some embodiments, the rank notifier 426 may communicate with a rank notification receiver module (such as module 411 of FIG. 5).

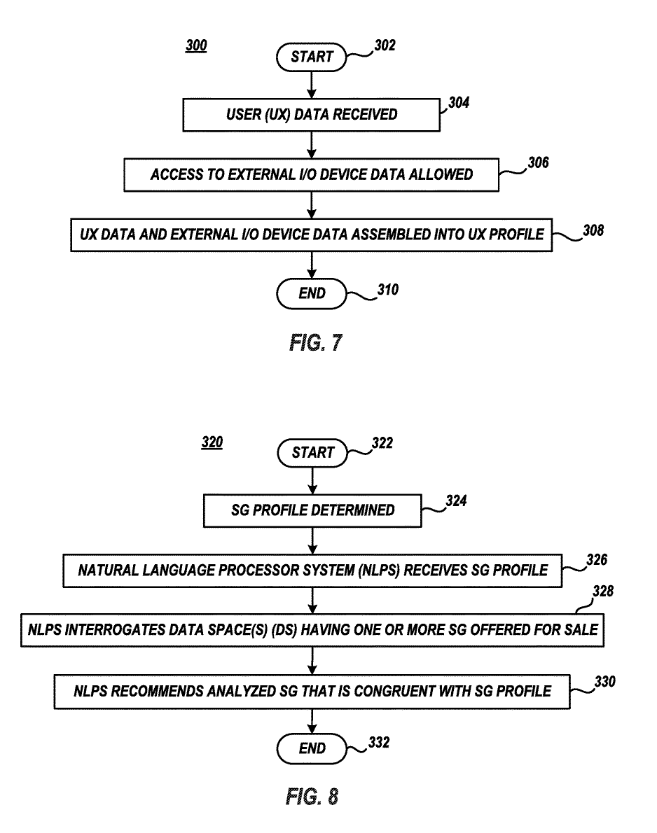

FIG. 7 illustrates an exemplary method 300 of determining or creating a user profile, such as UX profile 212, according to various embodiments of the present invention. Method 300 may be utilized by module 210 to determine or create a user profile for the user of both computer 100 and external I/O device 150. Method 300 begins at block 302 and may continue with module 210 receiving UX data (block 304). For example, module 210 may receive user data associated with the user interacting with an interface of computer 100, may receive user data associated with a question and answer module which queues questions to and receives inputs from the user of computer 100, may receive user data by receiving data associated with the user completing and submitting an user profile electronic document to e.g., computer 100, computer 181, or the like.

Method 200 continues by module 210 receiving permission to access or receive data determined by or otherwise stored upon external I/O device 150 (block 306). For example, module 210 may receive permission to access I/O device 150 data in association with the user interacting with an interface of computer 100, or the like. Method 200 may continue with receiving user data from I/O device 150 and assembling the user data into UX profile 212. If module 210 receives both user data from I/O device 150 and receiving UX data associated with block 204, the module 210 assembles the user data from I/O device 150 and UX data associated with block 204 into UX profile 212. Method 300 ends at block 310. The user profile 212 is a data package, such as a web page, electronic document, data structure, or the like that at least includes one UX data that was previously stored within I/O device 150. The user profile 212 may contains the user's body sizing data such as height, weight, waist circumference, neck circumference, chest circumference, foot width, foot length, or the like.

FIG. 8 illustrates an exemplary method 320 of analytically recommending an analyzed SG associated with SG data that is congruent with a preexisting SG profile 208, according to various embodiments of the present invention. Method 320 may be performed by for example, natural language processing system 422 to recommend one or more SG offered for sale by determining a degree of congruency between the SG profile 208 and data within an electronic document(s) of the one or more SG offered for sale.

Method 320 begins at block 322 and continues by background data module 200 determining the SG profile 208 of a particular preexisting SG (block 324). For example, an integrated I/O device module 202 utilizes camera 126 and touch screen 124 to harvest SG data. The computer 100 user captures an image of a code that is located upon, attached to, or otherwise associated with the SG. Subsequently, integrated I/O device module 202 scans the image of the code to harvest background data of the associated SG. Network module 204 optionally requests and receives supplemental or additional SG data, associated with the particular preexisting SG that is inherent to, integral to, or otherwise associated with the preexisting SG from a networked connected computer 180 that is controlled by an entity other than the user of computer 100. SG profile module 206 generally assembles the background data obtained from integrated I/O device module 202 and network module 204 into SG profile 208.

Method 320 may continue with natural language processing system 422 receiving the SG profile 208 (block 326). For example, product profile submission module 410 located upon computer 100 sends an webpage, electronic document, or the like that contains the SG profile 208 to natural language processing system 422 located upon computer 181 via network 130. The module 206, module 410, and computer 181 may be provided, controlled, maintained, or managed by the same entity.

Method 320 may continue with natural language processing system 422 interrogating or otherwise analyzing one or more electronic dataspace(s), such as web pages, electronic documents, or the like that list or include one or more SG offered for sale, herein referred to as an analyzed good or analyzed goods (block 328). For example, a natural language processor 514 utilizes a tokenizer module 516, a POS tagger module 518, semantic relationship identifier module 520, syntactic relationship identifier 522, and/or congruency analyzer module 524 to analyze the electronic dataspace(s) to determine the degree of congruency between the analyzed SG and the preexisting SG associated with SG profile 208.

Method 320 may continue with natural language processing system 422 recommending one or more analyzed SGs that are congruent with SG profile 208 (block 330). For example, the natural language processing system 422 may utilize congruency ranker module 430 to rank multiple analyzed SGs based upon the number of congruent data metrics between the SG profile 208 and the data within the data electronic dataspace(s) associated with the one or more analyzed SGs. The ranked analyzed SGs may be recommended by sending web page(s), electronic document(s), or the like associated with the ranked analyzed SGs to the computer 100 with rank notifer module 426. Upon computer 100, the web page(s), electronic document(s), or the like are received upon rank notification receiver module 411 and may be provided to the user of computer 100 via a computer 100 interface such as a touch screen 124. The provision of one or more analyzed SGs via the interface of computer 100 is an example of recommending to the user of computer 100 to purchase such analyzed SG(s). Method 320 ends at block 332.

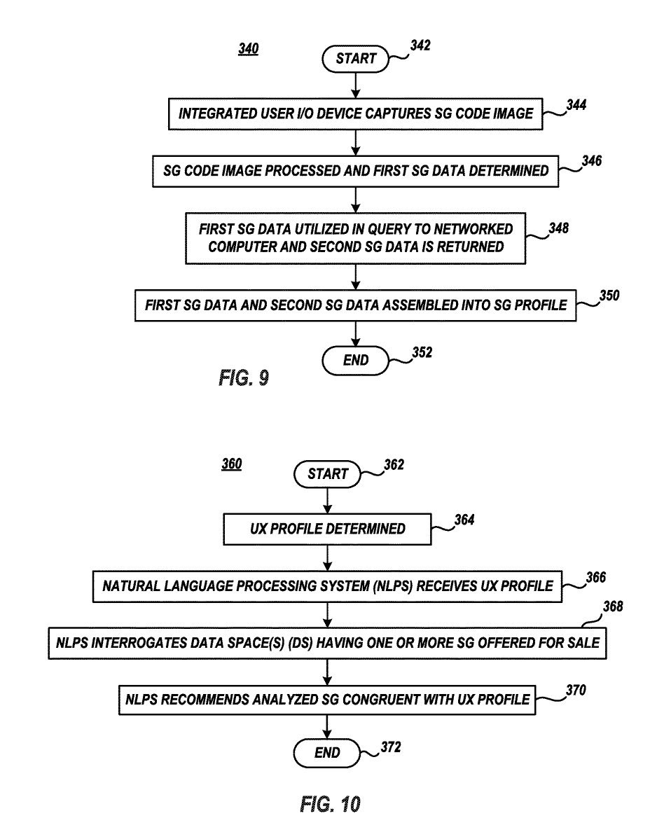

FIG. 9 illustrates an exemplary method 340 of determining or creating a SG profile 208, according to various embodiments of the present invention. Method 340 may be utilized by data module 200 to create SG profile 208 of a preexisting SG. Method 340 begins at block 342 and continues by integrated I/O device module 202 utilizing camera 126 and touch screen 124 to capture an image of a code, such as a bar code, QR code, or the like that is located upon, attached to, or otherwise associated with the preexisting SG (block 344).

Method 340 may continue with integrated I/O device module 202 scanning or otherwise processing the image of the code to read or otherwise accumulate first SG data of the preexisting SG (block 346). Exemplary first SG data may be an identifier of the SG, manufacturer of the SG, manufacturing location of the SG, price of the SG, style of the SG, cut of the SG, color of the SG, material of the SG, size of the SG, date of sale of the SG, date SG placed for sale, a web address containing additional SG data, or the like. In preferred embodiments, the first SG data is a pointer that may point to additional SG data that which network module 204 may obtain from a computer 180 via network 130. For example, the first SG data may be a web address associated with the preexisting SG.

Method 340 may continue with the first SG data being utilized in a query to networked computer 180, 181, or the like, the first SG data being utilized to harvest additional SG data by the networked computer 180, 181, and returning the harvested additional SG data to computer 100 (block 348). For example, the network module 204 may direct a browser (visible or not visible to the user) to the web address and may itself harvest additional SG data from the associated web page. In an embodiment, the query may cause another computer, such as computer 181, to harvest the additional SG data and return the additional SG data to network module 204.

Method 340 may continue with the first SG data and the additional SG data being assembled in to the SG profile 208 (block 350). For example, the first SG data obtained by the I/O device module 202 and the additional SG data obtained from network module 204 may be integrated into a single SG profile 208 by SG profile module 206. A particular SG profile 208 may be designated as a preferred profile 208 by the user of computer 100. For example, the user may utilize an interface of computer 100 to designate a particular SG associated with the SG profile 208 as the SG profile 208 which includes SG data associated with a preferred fit, which includes SG data associated with a preferred cut SG, which includes SG data associated with a preferred color, which includes SG data associated with a preferred size, or the like.

Method 340 may continue with SG profile module 206 assembling the first data obtained from integrated I/O device module 202 and the additional data into SG profile 208 (block 350). Method 340 ends at block 352.

FIG. 10 illustrates an exemplary method 360 of analytically recommending a SG that is offered for sale associated with data within an electronic document that is congruent with preexisting UX profile 212, according to various embodiments of the present invention. Method 360 may be performed by for example, natural language processing system 422 to recommend one or more SG offered for sale by determining a degree of congruency between the UX profile 212 and data within an electronic document(s) of the one or more SG offered for sale.

Method 360 begins at block 362 and continues with background data module 200 determining the UX profile 212 of a user of computer 100 (block 364). For example, an external I/O device module 203 receives UX data from external I/O device 150. The external I/O device module 203 may also receive UX data created by the user of computer 100 interacting with an interface of computer 100. For example, user profile module 210 may have a question and answer component that elicits and receives UX data by the user interacting with an interface of computer 100. UX profile module 210 generally assembles the UX data obtained from external I/O device module 203 and any additional UX data received by UX profile module 210 into UX profile 208.

Method 360 may continue with natural language processing system 422 receiving the UX profile 212 (block 366). For example, user profile submission module 409 located upon computer 100 sends a webpage, electronic document, or the like that contains the UX profile 212 to natural language processing system 422 located upon computer 181 via network 130. The module 210, module 409, and computer 181 may be provided, controlled, maintained, or managed by the same entity.

Method 360 may continue with natural language processing system 422 interrogating or otherwise analyzing one or more electronic dataspace(s), such as web pages, electronic documents, or the like that list or include one or more SG offered for sale, herein referred to as an analyzed good or analyzed goods (block 368). For example, a natural language processor 514 utilizes a tokenizer module 516, a POS tagger module 518, semantic relationship identifier module 520, syntactic relationship identifier 522, and/or congruency analyzer module 524 to analyze the electronic dataspace(s) to determine the degree of congruency between the analyzed SG and the UX profile 212.

Method 360 may continue with natural language processing system 422 recommending one or more analyzed SGs that are congruent with UX profile 212 (block 370). For example, the natural language processing system 422 may utilize congruency ranker module 430 to rank multiple analyzed SGs based upon the number of congruent data metrics between the UX profile 212 and the data within the data electronic dataspace(s) associated with the one or more analyzed SGs. The ranked analyzed SGs may be recommended by sending web page(s), electronic document(s), or the like associated with the ranked analyzed SGs to the computer 100 with rank notifer module 426. Upon computer 100, the web page(s), electronic document(s), or the like are received upon rank notification receiver module 411 and may be provided to the user of computer 100 via a computer 100 interface such as a touch screen 124. The provision of one or more analyzed SGs via the interface of computer 100 is an example of recommending to the user of computer 100 to purchase such analyzed SG(s). Method 360 ends at block 372.

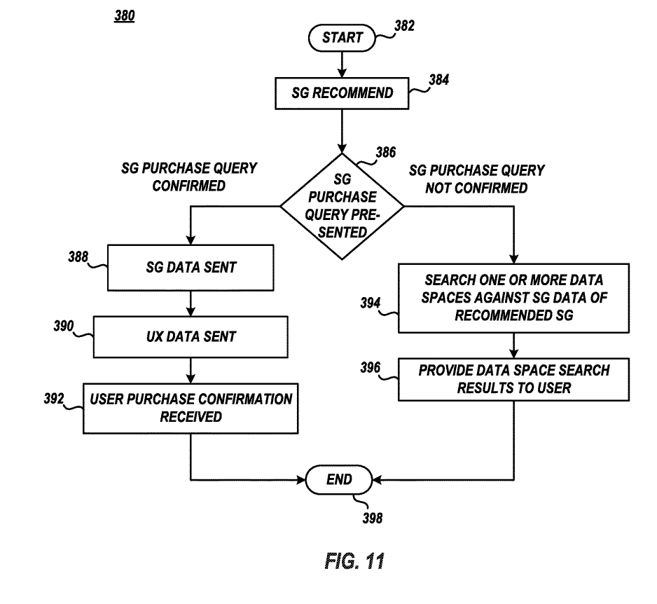

FIG. 11 illustrates an exemplary method 380 of managing an analytically determined purchase recommendation of a SG offered for sale, according to various embodiments of the present invention. Method 380 may be performed by one or more modules upon computer 100 to recommend an analyzed SG for purchase. Method 380 begins at block 382 and continues with one or more analyzed SG being recommended for purchase by providing an electronic document that contains one or more analyzed SG that is offered for sale upon an interface of computer 100 (block 384).

Method 380 may continue with providing a SG query to the user of computer 100 upon an interface of computer 100 (block 386). For example, a dialog window is presented upon touch screen 124 that asks the user to confirm the purchase of an analyzed SG deemed congruent by natural language processing system 422.

Method 380 may continue with sending SG data to a networked computer utilized by the entity that is offering the analyzed SG for sale if the user of computer 100 confirms the purchase of the analyzed SG (block 388). For example, the size, color, cut, style number, identification number, or other such SG data is sent from computer 100 to a networked computer that is hosting the electronic document that which offers the analyzed SG for sale.

Method 380 may continue with sending UX data to the entity that is offering the analyzed SG data to a networked computer utilized by the entity that is offering the analyzed SG for sale if the user of computer 100 confirms the purchase of the analyzed SG (block 390). For example, the user's name, address, credit card number, or other such UX data is sent from computer 100 to a networked computer that is hosting the electronic document that which offers the analyzed SG for sale.

Method 380 may continue with computer 100 receiving a purchase confirmation of the analyzed SG from the networked computer utilized by the entity that is offering the analyzed SG for sale (block 392). For example, computer 100 receives an electronic document having a receipt of purchase of the analyzed SG from the networked computer utilized by the entity that is offering the analyzed SG for sale.

Method 380 may continue with computer 100 searching within one or more data spaces containing numerous electronic documents against SG data of the recommended analyzed SG if the user of computer 100 does not confirm the purchase of the analyzed recommended SG (block 394). For example, computer 100 may perform an image search with the SG name, identification number, or other SG data within one or more particular data spaces (i.e. social media data space, search engine data space, or the like).

Method 380 may continue with providing the data space search results to the user of computer 100 upon an interface of computer 100. For example, images of the recommended analyzed SG may be presented to the user of computer 100 upon touch screen 124. Method 380 ends at block 398.

The flowcharts and block diagrams in the Figures illustrate exemplary architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over those found in the marketplace, or to enable others of ordinary skill in the art to understand the embodiments disclosed herein.

What is claimed is:

1. A method of managing a purchase recommendation of a softline good (SG) with a computer comprising a processor and memory, the method comprising:
analyzing an image of a code upon a label that is attached to a preexisting SG to determine first SG data;
generating, with a SG profile module stored upon the memory, a SG profile comprising the first SG data;
receiving, from an external input output (I/O) device connected to the computer by a short-range communication connection, user (UX) data describing the user of the computer and the external I/O device;
generating, with a UX profile module stored upon the memory, a UX profile comprising the UX data;
recommending, with a natural language processing system, a second SG should be purchased by:
comparing analyzed data within an electronic document of the second SG against the SG profile and against the UX profile;
determining a number of congruent metrics between the electronic document of the second SG and the SG profile;
determining a number of congruent metrics between the electronic document of the second SG and the UX profile; and
determining a total number of congruent metrics between the electronic document of the second SG and the SG profile and between the electronic document of the second SG and the UX profile.

2. The method of claim 1, further comprising:
capturing, with one or more integrated I/O devices of the computer, the image of the code upon the label attached to the SG; and
scanning, with a user I/O device module stored upon the memory, the image of the code upon the label.

3. The method of claim 1, wherein generating the SG profile comprises:
requesting and receiving, with a network module stored upon the memory, supplemental SG data from a networked computer attached to the computer via a network, the networked computer maintained by an entity other than the user of the computer and the external I/O device.

4. The method of claim 1, wherein the natural language processing system comprises: a tokenizer, a sematic relationship identifier, a syntactic relationship identifier, and a congruency analyzer.

5. The method of claim 1, wherein determining the number of congruent metrics between the electronic document of the second SG and the SG profile comprises:
indicating a congruent metric when a first metric within the electronic document of the second SG is the same as an equivalent respective metric within the SG profile.

6. The method of claim 1, wherein determining the number of congruent metrics between the electronic document of the second SG and the SG profile comprises:
indicating a congruent metric when a first metric within the electronic document of the second SG fits within a range of equivalent respective metrics within the SG profile.

7. The method of claim 1, wherein determining the number of congruent metrics between the electronic document of the second SG and the UX profile comprises:
indicating a congruent metric when a first metric within the electronic document of the second SG is the same as an equivalent respective metric within the UX profile.

8. The method of claim 1, wherein determining the number of congruent metrics between the electronic document of the second SG and the UX profile comprises:
indicating a congruent metric when a first metric within the electronic document of the second SG fits within a range of equivalent respective metrics within the UX profile.

9. The method of claim 1, wherein the code is a quick response (QR) code.

10. The method of claim 9, wherein the external I/O device is a smart watch.

11. A computer program product for managing a purchase recommendation of a softline good (SG) with a computer, the computer program product comprising a computer readable storage medium having program instructions embodied therewith, the program instructions are readable by the computer to cause the computer to:
analyze an image of a code upon a label that is attached to a preexisting SG to determine first SG data;
generate, with a SG profile module stored upon the memory, a SG profile comprising the first SG data;
receive, from an external input output (I/O) device connected to the computer by a short-range communication connection, user (UX) data describing the user of the computer and the external I/O device;
generate, with a UX profile module stored upon the memory, a UX profile comprising the UX data;
recommend, with a natural language processing system, a second SG should be purchased by:
comparing analyzed data within an electronic document of the second SG against the SG profile and against the UX profile;
determining a number of congruent metrics between the electronic document of the second SG and the SG profile;
determining a number of congruent metrics between the electronic document of the second SG and the UX profile; and
determining a total number of congruent metrics between the electronic document of the second SG and the SG profile and between the electronic document of the second SG and the UX profile.

12. The computer program product of claim 1, wherein the program instructions are readable by the computer to further cause the computer to:
capture, with one or more integrated I/O devices of the computer, the image of the code upon the label attached to the SG; and
scan, with a user I/O device module stored upon the memory, the image of the code upon the label.

13. The computer program product of claim 11, wherein the program instructions that generate the SG profile further cause the computer to:
request and receive, with a network module stored upon the memory, supplemental SG data from a networked computer attached to the computer via a network, the networked computer maintained by an entity other than the user of the computer and the external I/O device.

14. The computer program product of claim 11, wherein the natural language processing system comprises: a tokenizer, a sematic relationship identifier, a syntactic relationship identifier, and a congruency analyzer.

15. The computer program product of claim 1, wherein the program instructions that determine the number of congruent metrics between the electronic document of the second SG and the SG profile further cause the computer to:
indicate a congruent metric when a first metric within the electronic document of the second SG is the same as an equivalent respective metric within the SG profile.

16. The computer program product of claim 1, wherein the program instructions that determine the number of congruent metrics between the electronic document of the second SG and the SG profile further cause the computer to:
indicate a congruent metric when a first metric within the electronic document of the second SG fits within a range of equivalent respective metrics within the SG profile.

17. The computer program product of claim 1, wherein the program instructions that determine the number of congruent metrics between the electronic document of the second SG and the UX profile further cause the computer to:
indicate a congruent metric when a first metric within the electronic document of the second SG is the same as an equivalent respective metric within the UX profile.

18. The computer program product of claim 1, wherein the program instructions that determine the number of congruent metrics between the electronic document of the second SG and the UX profile further cause the computer to:
indicating a congruent metric when a first metric within the electronic document of the second SG fits within a range of equivalent respective metrics within the UX profile.

19. The computer program product of claim 1, wherein the code is a quick response (QR) code and wherein the external I/O device is a smart watch.

20. A computer comprising:
a processor; and
memory communicatively coupled to the processor, wherein the memory is encoded with instructions, wherein the instructions when executed by the processor cause the processor to:
analyze an image of a code upon a label that is attached to a preexisting SG to determine first SG data;
generate, with a SG profile module stored upon the memory, a SG profile comprising the first SG data;
receive, from an external input output (I/O) device connected to the computer by a short-range communication connection, user (UX) data describing the user of the computer and the external I/O device;
generate, with a UX profile module stored upon the memory, a UX profile comprising the UX data;
recommend, with a natural language processing system, a second SG should be purchased by:
comparing analyzed data within an electronic document of the second SG against the SG profile and against the UX profile;
determining a number of congruent metrics between the electronic document of the second SG and the SG profile;
determining a number of congruent metrics between the electronic document of the second SG and the UX profile; and
determining a total number of congruent metrics between the electronic document of the second SG and the SG profile and between the electronic document of the second SG and the UX profile.
